(19) United States
(12) Patent Application Publication
(10) Pub. No.: US 2016/0125547 A1
(43) Pub. Date: May 5, 2016

(54) Self-Directed Insurance Accounts

(71) Applicant: The Toronto-Dominion Bank, Toronto (CA)

(72) Inventors: Martin Joseph Marcel Dubeau, Quebec (CA); Jakub Danielak, Ontario (CA)

(21) Appl. No.: 14/871,505

(22) Filed: Sep. 30, 2015

Related U.S. Application Data
(63) Continuation of application No. 14/528,676, filed on Oct. 30, 2014.

(51) Int. Cl. G06Q 40/08

(52) U.S. Cl. CPC G06Q 40/08

(57) ABSTRACT

The present disclosure involves systems including a life insurance platform and a user-directed investment platform. The life insurance platform maintains a life insurance policy associated with a cash value backed by investment assets. A user-directed investment account platform maintains a user-directed investment account funded by a margin account based on the cash value of the life insurance policy. The system can determine a change in the value of the investment assets and can, in turn, modify the value of the margin account based on the change. The user-directed investment account platform can identify the modified value of the margin account and update the user-directed investment account based on the same. That platform can also provide an interface for providing information related to the user-directed investment account while also providing information related to the life insurance policy.

### CROSS-REFERENCE TO RELATED APPLICATIONS

This application is a continuation of and claims the benefit of priority to U.S. patent application Ser. No. 14/528,676, filed on Oct. 30, 2014, the contents of which are hereby incorporated by reference.

### TECHNICAL FIELD

The present disclosure relates to computer systems and software that implement algorithms and other operations for combining electronic life insurance policy accounts and self-directed investment accounts.

### BACKGROUND

Life insurance is a contract between a policy holder, and an insurer, where the insurer promises to pay a designated beneficiary a sum of money in exchange for a premium upon the death of the insured person(s) listed in the policy. The policy holder typically pays the premium as a lump sum or on a periodic, regular basis. Life insurance policies are legal contracts with terms that define the limitations of insured events, often including specific exclusions to protect the insurer and limit their liability. Life insurance policies include term insurance and permanent life insurance policies (e.g., whole life, universal life, and variable life policies).

Permanent life insurance is life insurance that remains active until insured's death, unless the policy owner fails to pay the premium when due. Permanent insurance policies can accumulate cash values, which the owner can access by withdrawing money, borrowing against the cash value, or surrendering the policy and receiving the surrender value.

Universal life insurance is a type of permanent life insurance. Under universal life policies, the excess of the premium payments above the current cost of insurance and any fees and taxes is credited to the cash value of the policy. The cash value is credited each month with investment income, while the policy is debited each month by a cost of insurance charge and other policy charges and fees.

Self-directed investment accounts allow account owners to direct their own accounts by selecting from a range of investments. In some instances, a portion of the funds within may include a managed account context, or an account where a manager can assist the account owner in selecting funds or making investment decisions. Permanent life insurance policies are not associated with self-directed investment accounts and instead can typically only hold a limited number of investment vehicles, which are generally limited to guaranteed return interest rates, professionally managed funds or market indices. Self-directed accounts provide flexibility to the account owner in allowing funds to be distributed and invested in owner-specified accounts and investments.

### SUMMARY

The present disclosure involves systems, software, and computer-implemented methods for providing combined life insurance policies with self-directed investment accounts. The system may include a life insurance platform including at least one processor that executes operations to maintain a life insurance policy for a user, the life insurance policy associated with a cash value that is backed by investment assets. The system may also include a user-directed investment account platform including at least one processor that executes operations to maintain a user-directed investment account associated with the life insurance policy, wherein the user-directed investment account can be funded with a cash account and/or a margin account based at least in part on an initial cash value of the life insurance policy. At least one of the life insurance platform and the user-directed investment account platform can determine a delta of the value of the investment assets backing the cash value of the life insurance policy and modify the value of the margin account based on the determined delta. The user-directed investment account platform can identify the modified value of the margin account, store the modified value of the margin account, and update the user-directed investment account based on the modified value of the margin account. Further, the user-directed investment account platform can provide a web-based interface for providing information related to the user-directed investment, wherein the web-based interface presents account details of the user-directed investment account, access the life insurance platform to identify information related to the life insurance policy, and present, via the web-based interface, at least a portion of the identified information related to the life insurance policy with the account details of the user-directed investment account.

In some instances, the user-directed investment account platform can distribute investment assets associated with the life insurance policy based on direct instructions from the user. In some instances, the distribution of investment assets comprises a series of periodic loans against the value of the margin account used to fund periodic income payments to the user. In some instances, the life insurance platform is maintained by a first entity providing life insurance policies, and wherein the direct investing platform is maintained by an investment firm. In some instances, the direct investing platform is managed by a third-party administrator distinct from the first entity managing the life insurance platform.

In some instances, the identified information related to the life insurance policy is presented seamlessly in-line with the account details of the user-directed investment account. At least a portion of the funds in the user-directed investment account may be used to pay at least a portion of premiums for the life insurance policy.

In some instances, the user-directed investment account platform can electronically and/or via telephone-based instruction invest funds in the user-directed investment account in one or more of the following: individual equities, options, bonds, money market offerings, mortgage-backed securities, real estate-backed securities, real estate investment trusts (REITs), exchange-traded funds (ETFs), mutual funds, index funds, and precious metal certificates.

The life insurance policy may be a universal life insurance policy in some implementations. The value of the margin account can be a pre-determined percentage of the cash value of the life insurance policy. In some instances, the margin account includes at least one asset other than the value of the life insurance policy. Additionally, the margin account is calculated, at least in part, on at least one asset held in a different user-directed investment account.

While generally described as a system, some or all of the aspects may be computer-implemented methods, computer-implemented software embodied on tangible media that processes and transforms the respective data, or included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for providing combined life insurance accounts with self-directed investment accounts.

FIG. 2 is a swim-lane diagram illustrating example operations at a direct investment platform and a life insurance platform for initiating and onboarding combined life insurance accounts with self-directed investment accounts.

FIG. 3 is a flowchart of an example operation for associating and presenting account information associated with a life insurance policy and an associated self-directed investment account.

FIG. 4 is a flowchart of an example operation for maintaining a life insurance account and a separate, but related, self-directed investment account.

FIG. 5 is a swim-lane diagram illustrating example operations for managing and applying excess deposits into a life insurance policy described in the present application.

FIG. 6 is a swim-lane diagram illustrating example operations for usage of a margin account associated with and backed by the life insurance policy, where the account owner can invest or deaccumulate the margin account.

FIGS. 7-10 are example screenshots providing illustrations of various web interfaces incorporating information from both an investment platform and a life insurance platform in seamless combination.

### DETAILED DESCRIPTION

Traditional universal life insurance options provide significantly limited investment options, if any. The present application describes a system wherein customers can associate a user-directed investment account with the universal life insurance policy (or other permanent life insurance products) to provide the benefits of permanent insurance and its increasing cash value with the independence provided by a user-directed investment account. In general, universal life insurance policies typically gain value over time based on the increasing investment portion of the customers' paid premiums and, in some cases, dividends or other funds. The value of universal life insurance policies are in their flexibility. Specifically, such accounts allow the customer, or policy owner, to shift money between the insurance and savings components of the policy. Premiums, which may be variable, are separated by the insurance company into insurance costs and savings, thereby allowing the policy owner to make adjustments to their premiums and insurance coverage in response to their individual circumstances. For example, if the savings portion is earning a low return, that portion can be used instead of external funds to pay the premiums. Universal life can also allow the cash value of investments to grow at a variable rate that is adjusted monthly.

The self-directed insurance account (SDIA) described herein combines the tax-sheltering potential of life insurance with direct investment capabilities. Today, forms of permanent insurance such as universal life exist to defer and/or avoid some income tax, although none offer the insured full control over how assets are managed. The SDIA is a unique partnership between two distinct types of financial services, online discount brokers and life insurers. The creation of an insurance account on the direct investment platforms is unique in its benefits to consumers, as well as its technical integration with the life insurance account. To provide the described solution, new onboarding and self-service procedures are required, as the system removes the customary reliance on the traditional distribution, relationship, and servicing structure of the financial services. For example, as opposed to former accounts where changes to life insurance investment accounts were made through a life insurance advisors or associated brokers, users can now access and direct their self-directed investment accounts through the functionality of an investment platform capable of accessing and updating the investment account through continuous and on-going interaction with the life insurance policy. The life insurance platform can be accessed through the investment platform on a continuous or periodic basis to identify modifications to a margin account associated with the life insurance policy and to modify the funds available for borrowing against the self-directed insurance account. Additionally, through gains earned by the self-directed insurance account, customers are able to pay premiums associated with their life insurance policy and to further increase the cash value of the policy.

The SDIA further provides a unique borrowing mechanism allowing the life insurance policy cash value to be used as collateral in order to increase the available credit margin on the associated SDIA. In some jurisdictions, the mechanism may be used to avoid tax dispositions on policy loans or withdrawals as well as an effective way to deaccumulate savings at retirement.

Traditional universal life policies may have significant inherent limitations. For example, such policies may be limited in the investment options available and may include a limited number of mutual funds, guaranteed investment certificates or contracts (GICs), or limited currencies. Comparatively, the SDIA allows policy owners to also invest in corporate and governmental bonds, stock and stock derivatives (including options), preferred shares, bonds, money market offerings, commercial and other mortgage-backed securities, precious metal certificates, real estate-backed securities, exchange-traded funds (ERFs), real estate investment trusts (REITs), and US and Canadian dollars as well as other currencies. Traditional universal life policies may levy expense charges on assets as a percentage of assets held at the end of each month. The SDIA may not charge on assets (excluding fund management expense ratios (MERs)) and may only charge fees per transactions similar to lower cost transaction brokerage accounts.

With regard to policy withdrawals, only a portion of the cash value may be available to traditional life insurance policies. For the SDIA, however, assets held in the insurance account can increase the margin limit available on the insurance account for investing and loans, thus eliminating any taxable disposition on policy loans for some jurisdictions. In some instances, traditional universal life policies charge penalties on withdrawals within the first 10 years of the policy. The SDIA avoids such charges on withdrawals, as the direct model removes compensation paid to brokers.

Another significant benefit of the SDIA is the real-time ability to make and modify investments. Traditional universal life policies are subject to procedural delays, including contacting an insurance advisor to update the policy, as well as any actions to be performed by the advisor/agent in enacting the requested changes.

With regard to the asset deaccumulation phase, policy owners of traditional universal life policies who wish to obtain a loan against their policy cash value must work to try securing a loan from another financial institution. With the SDIA, the policy owner can borrow funds outside of the policy using the available consolidated margin account.

For traditional universal life policies, when the insured stops paying premiums or the account value is exhausted, the policy will lapse. The SDIA can provide an option to use the margin account available to pay for insurance premiums in order to avoid lapses when premiums are not received from their normal funding source. Alternatively, the SDIA can use gains from the insurance account to pay the insurance premiums, thereby avoiding out-of-pocket expenses.

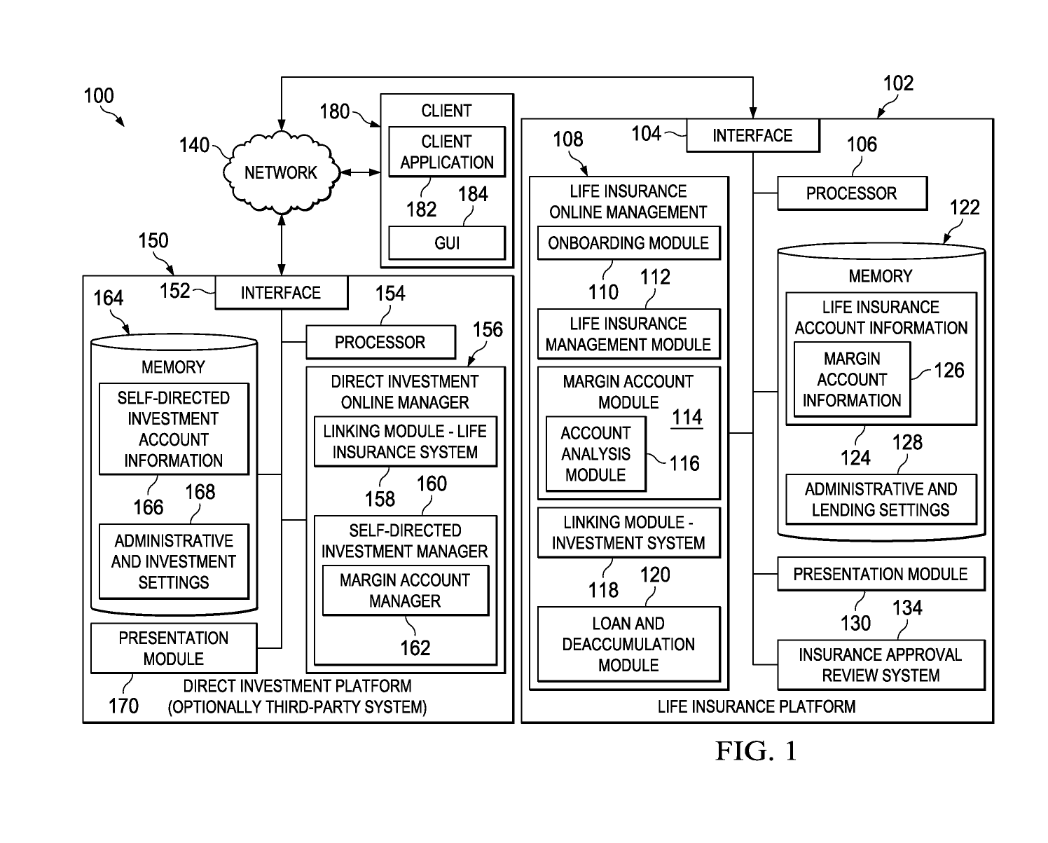

FIG. 1 is a block diagram illustrating an example system 100 for providing combined life insurance accounts with self-directed investment accounts. As illustrated in FIG. 1, system 100 includes or is communicably coupled with a life insurance platform 102, a direct investment platform 150, a network 140, and a client 180. Although components are shown individually, in some implementations, functionality of two or more components, systems, or servers may be provided by a single component, system, or server. Similarly, in some implementations the functionality of one illustrated component, system, or server may be provided by multiple components, systems, servers, or combinations thereof. Conversely, multiple components may be combined into a single component, system, or server, where appropriate.

As used in the present disclosure, the term “computer” is intended to encompass any suitable processing device. For example, life insurance platform 102 and direct investment platform 150 may each be any computer or processing device such as, for example, a blade server, general-purpose personal computer (PC), Mac®, workstation, UNIX-based workstation, or any other suitable device. Moreover, although FIG. 1 illustrates a single life insurance platform 102, platform 102 can be implemented using two or more systems, as well as computers other than servers, including a server pool. Similarly, the direct investment platform 150 can be implemented as multiple systems or servers. In other words, the present disclosure contemplates computers other than general purpose computers, as well as computers without conventional operating systems. Further, illustrated client 180, life insurance platform 102, and direct investment platform 150 may be adapted to execute any operating system, including Linux, UNIX, Windows, Mac OS®, Java™, Android™, iOS or any other suitable operating system. According to one implementation, the illustrated systems may also include or be communicably coupled with an e-mail server, a Web server, a caching server, a streaming data server, and/or other suitable server or computer.

In general, the life insurance platform 102 is used to maintain one or more life insurance policies for users. Each life insurance policy is associated with a cash value backed by a set of investment assets. The directed investment platform 150 maintains a user-directed insurance or investment account associated with at least one of the life insurance policies maintained by the life insurance platform 102. The user-directed account is funded based on a margin account determined based, at least in part, on the cash value of the corresponding life insurance policy and any other cash or assets invested in the margin account. The life insurance platform 102 functions to receive insurance premiums covering the cost of insurance plus a savings component.

The life insurance platform 102 and/or the direct investment platform 150 can determine a change or delta associated with the value of the investment assets backing the cash value of the life insurance policy. In response to the detection, the life insurance platform 102 and/or the direct investment platform 150 can modify the allowed value of the margin account by an amount proportional to the identified delta. The directed investment platform 150 can identify the modified value of the margin account, store the modified value, and update the user-directed investment account based on the modified margin account value. For example, the user-directed account can allow the account owner to purchase additional investments based on an increased margin account value.

The directed investment platform 150 may also be able to provide a web-based interface for providing account owners with detailed information related to their account. In doing so, account owners with life insurance policies can view account information and details of the user-directed investment account. Additionally, however, the user-directed investment account can access the life insurance platform to identify account information related to the life insurance policy. The information can then be presented along with the account information for the user-directed investment account via the web-based interface.

The client 180 may be any computing device operable to connect to or communicate with at least the life insurance platform 102 and/or the direct investment platform 150 via network 140 using a wireline or wireless connection, and can include a desktop computer, a mobile device, a tablet, a server, or any other suitable computer device. In general, the client 180 comprises an electronic computer device operable to receive, transmit, process, and store any appropriate data associated with the environment 100 of FIG. 1. Client 180 executes a client application 182 operable to access one or more of the life insurance platform 102 and the direct investment platform 150, particularly for information related to life insurance and investment accounts associated with a user of the client 180. Client 180 can also include a graphical user interface (GUI) 184. The GUI 184 interfaces with at least a portion of the environment 100 for any suitable purpose, including generating a visual representation of a Web browser and/or the client application 182. In particular, the GUI 184 may be used to view and navigate various Web pages located both internally and externally to environment 100, as well as to view and navigate through information accessed by the client application 182, such as information stored at or associated with one or both of the life insurance platform 102 and/or the direct investment platform 150. Generally, the GUI 184 provides the particular user with an efficient and user-friendly presentation of data provided by or communicated within the system. The GUI 184 may comprise a plurality of customizable frames or views having interactive fields, pull-down lists, and buttons operated by the user. For example, the GUI 184 may provide interactive elements that allow a user to view or interact with accounts such as life insurance accounts or SDIAs. The GUI 184 may present information associated with the client application 182 for viewing and interaction. In general, the GUI 184 is often configurable, supports a combination of tables and graphs (bar, line, pie, status dials, etc.), and is able to build real-time portals, where tabs are delineated by key characteristics (e.g., site or micro-site). Therefore, the GUI 184 contemplates any suitable graphical user interface, such as a combination of a generic web browser, intelligent engine, and command line interface (CLI) that processes information in the platform and efficiently presents the results to the user visually.

The illustrated client 180 is intended to encompass any computing device such as a desktop computer, laptop/notebook computer, wireless data port, smart phone, personal data assistant (PDA), tablet computing device, one or more processors within these devices, or any other suitable processing device. For example, the client 180 may comprise a computer that includes an input device, such as a keypad, touch screen, or other device that can accept user information, and an output device that conveys information associated with the operation of the client application 182 or the client 180 itself, including digital data, visual information, or a GUI 184, as shown with respect to the client 180.

Network 140 facilitates wireless or wireline communications between the components of the environment 100 (i.e., between the client 180 and the life insurance platform 102 and/or the direct investment platform 150, as well as between the life insurance platform 102 and the direct investment platform 150), as well as with any other local or remote computer, such as additional clients, servers, or other devices communicably coupled to network 140, including those not illustrated in FIG. 1. In the illustrated environment, the network 140 is depicted as a single network, but may be comprised of more than one network without departing from the scope of this disclosure, so long as at least a portion of the network 140 may facilitate communications between senders and recipients. In some instances, one or more of the illustrated components may be included within network 140 as one or more cloud-based services or operations. The network 140 may be all or a portion of an enterprise or secured network, while in another instance, at least a portion of the network 140 may represent a connection to the Internet. In some instances, a portion of the network 140 may be a virtual private network (VPN). Further, all or a portion of the network 140 can comprise either a wireline or wireless link. Example wireless links may include 802.11a/b/g/n, 802.20, WiMax, LTE, and/or any other appropriate wireless link. In other words, the network 140 encompasses any internal or external network, networks, sub-network, or combination thereof operable to facilitate communications between various computing components inside and outside the illustrated environment 100. The network 140 may communicate, for example, Internet Protocol (IP) packets, Frame Relay frames, Asynchronous Transfer Mode (ATM) cells, voice, video, data, and other suitable information between network addresses. The network 140 may also include one or more local area networks (LANs), radio access networks (RANs), metropolitan area networks (MANs), wide area networks (WANs), all or a portion of the Internet, and/or any other communication system or systems at one or more locations.

The life insurance platform 102 represents a computer system, including one or more servers, computers, processors, and other components, that supports and maintains the issuance and maintenance of life insurance policies, particularly those associated with a corresponding SDIA as described above. The life insurance platform 102 includes an interface 104, a processor 106, a life insurance online management module 108, memory 122, a presentation module 130, and an insurance approval review system 134. In general, the life insurance platform 102 is a simplified representation of one or more systems and/or servers that provide and maintain life insurance policies, and is not meant to be limiting, but rather an example of the systems possible. Additional components may be included in or associated with the life insurance platform 102, including policy administration, claims administration, billing, and others, as needed.

As used in the present disclosure, the term “computer” is intended to encompass any suitable processing device. For example, although FIG. 1 illustrates a single life insurance platform 102, environment 100 can be implemented using two or more systems, as well as computers other than servers, including a server pool. In fact, life insurance platform 150 may be any computer or processing device such as, for example, a blade server, general-purpose personal computer (PC), Mac®, workstation, UNIX-based workstation, or any other suitable device. Similarly, the direct investment platform 150 can be implemented as multiple systems or servers. In other words, the present disclosure contemplates computers other than general purpose computers, as well as computers without conventional operating systems. Further, illustrated client 180, life insurance platform 102, and direct investment platform 150 may be adapted to execute any operating system, including Linux, UNIX, Windows, Mac OS®, Java™, Android™, iOS, or any other suitable operating system. According to one implementation, the illustrated systems may also include or be communicably coupled with an e-mail server, a Web server, a caching server, a streaming data server, and/or other suitable server or computer.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component may be fully or partially written or described in any appropriate computer language including C, C++, JavaScript, Java™, Visual Basic, assembler, Perl®, any suitable version of 4GL, as well as others.

The interface 104 is used by the life insurance platform 102 for communicating with other systems in a distributed environment—including within the environment 100—connected to the network 140, e.g., the direct investment platform 150, client 180, and other systems communicably coupled to the network 140. Generally, the interface 104 comprises logic encoded in software and/or hardware in a suitable combination and operable to communicate with the network 140. More specifically, the interface 104 may comprise software supporting one or more communication protocols associated with communications such that the network 140 or interface's hardware is operable to communicate physical signals within and outside of the illustrated environment 100.

As illustrated in FIG. 1, the life insurance platform 102 includes a processor 106. Although illustrated as a single processor 106 in FIG. 1, two or more processors may be used according to particular needs, desires, or particular implementations of the environment 100. Each processor 106 may be a central processing unit (CPU), an application specific integrated circuit (ASIC), a field-programmable gate array (FPGA), or another suitable component. Generally, the processor 106 executes instructions and manipulates data to perform the operations of the life insurance platform 102. Specifically, the processor 106 executes the algorithms and operations described in the illustrated figures, including the operations performing the functionality associated with the life insurance platform 102 generally, as well as the various software modules (e.g., the life insurance online management module 108, the presentation module 130, and others), including the functionality for sending and receiving communications and transmissions to and from the direct investment platform 150.

The illustrated life insurance platform 102 also includes memory 122, or multiple memories 122. The memory 122 may include any memory or database module and may take the form of volatile or non-volatile memory including, without limitation, magnetic media, optical media, random access memory (RAM), read-only memory (ROM), removable media, or any other suitable local or remote memory component. The memory 122 may store various objects or data, including financial data, administrative settings, passwords information, caches, applications, backup data, repositories storing business and/or dynamic information, and any other appropriate information including any parameters, variables, algorithms, instructions, rules, constraints, or references thereto associated with the purposes of the life insurance platform 102. Additionally, the memory 122 may store any other appropriate data, such as VPN applications, firmware logs and policies, firewall policies, a security or access log, print or other reporting files, as well as others. For example, memory 122 can store electronic life insurance account information 124 associated with one or more life insurance policies, including, where appropriate, margin account information 126. In some instances, the margin account information 126 may be specific information about one or more margin accounts, as well as parameters associated with a percentage of the cash value for which loans and margin accounts will be calculated. In some instances, margin accounts may be authorized to a particular percentage of the cash value of the investment assets of the life insurance policy. In others, the particular percentage may be an initial margin value, with individual information taken into account to determine the appropriate amount for the margin value account. The life insurance account information 124 can store information on life insurance policies for a plurality of policy owners and can provided varying margin account percentages and calculations, which can vary based on each policy owner's individual financial information. Memory 122 further includes a set of administrative and lending settings 128 that can provide rules and settings related to new life insurance policies being issued, rules defining the decisions used to determine the size of a margin account for various policy owners, and other settings related to the life insurance platform 102. In some instances, the administrative and lending settings 128 may include password and login information to the life insurance platform 102, among other settings.

The life insurance online management module 108 represents an application, set of applications, software, or a combination of software and hardware used to manage the online interactions of the life insurance platform 102. In the present solution, the life insurance online management module 108 can perform operations including onboarding policy holders (e.g., providing life insurance applications to users, receiving application information, approving or managing the approval of life insurance applications), determining margin account values or ratios, providing information to or retrieving information from the direct investment platform, and assisting in the deaccumulation of assets from the life insurance policy, among others. Specifically, the life insurance online management module 108 can transform data associated with the life insurance account based on information received from policy holders, the direct investment platform 150, and other automated systems. Upon transferring the data, the life insurance online management module 108 can store the updated information for future use, including for updating the margin account calculation. The life insurance online management module 108 can include various functionality to assist in the management and maintenance of the life insurance policies. As illustrated in FIG. 1, the life insurance online management module 108 includes an onboarding module 110, a life insurance management module 112, a margin account module 114, a linking module 118, and a loan and deaccumulation module 120. Additional modules and functionality may be included in alternative implementations.

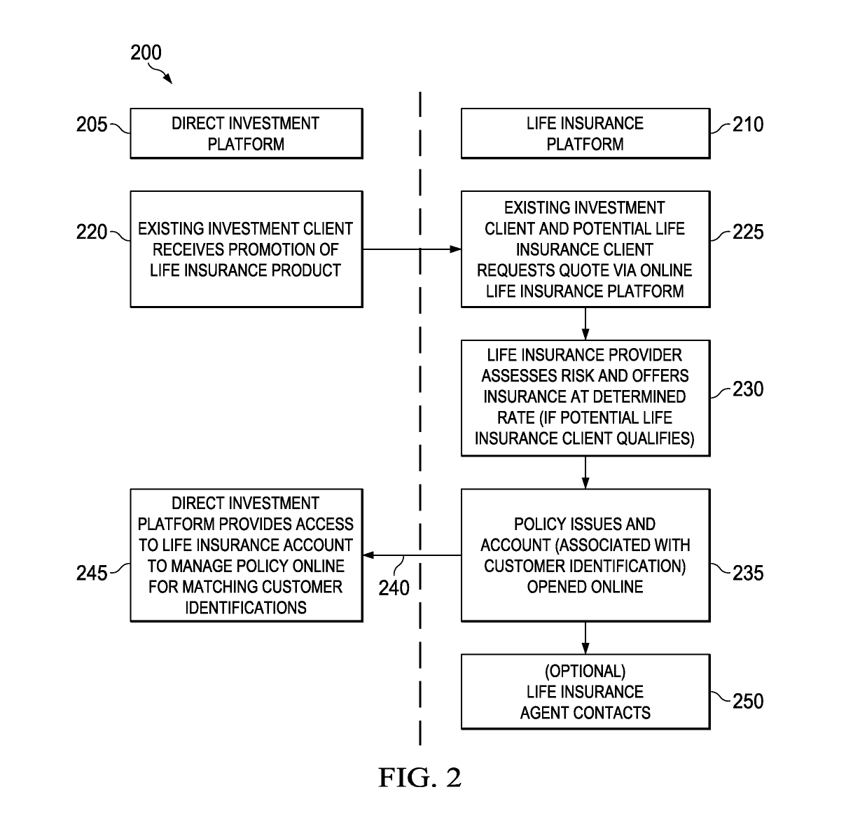

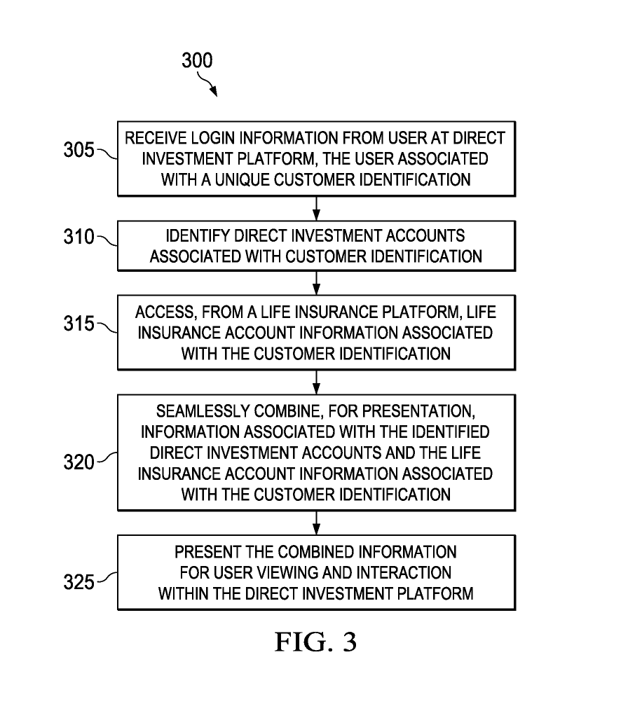

The onboarding module 110 manages the onboarding process of the life insurance policy, including receiving information from a direct investment platform 150. Further descriptions of this process are provided by FIGS. 2 and 3. The life insurance management module 112 generally performs operations associated with the ongoing maintenance and management of particular life insurance policies, and may include premium payment and reminder functionality, periodic communications to policy owners, and other routine life insurance activities. In some instances, the life insurance management module 112 may coordinate or work with individuals associated with the insurer to perform maintenance on certain policies and accounts, provide reminders to agents of the insurer, identify issues and notifications for policy owners, and other assorted tasks. In some instances, the life insurance management module 112 may handle payments of insurance premiums via automatic deductions from the SDIA, e.g., as planned or when payment through an expected channel is not received on time.

The margin account module 114 can apply margin account rules stored in the administrative and lending settings 128 to perform initial and ongoing determinations as to the values of the margin accounts associated with the various life insurance policies. In some instances, the margin account module 114 may act independently based on information received in the life insurance application and based on ongoing information identified during the life of a policy to determine the appropriate margin account value for an account. The margin account module 114 is illustrated as including an account analysis module 116 which can be used to identify additional information about policy holders to determine risk information, credit history information, health information, and other data relevant to the account and the margin value. In some instances, users associated with the insurer can input information into the life insurance platform 102 which can be used by the margin account module 114 to perform the analysis.

The linking module for the direct investment system 118 is a component used to share information with or retrieve information from the direct investment platform 150. The linking module 118 may represent at least one application programming interface (API) accessible to the direct investment platform 150 where information associated with the life insurance policy can be obtained. Conversely, the linking module 118 may be capable of accessing APIs located at the direct investment platform 150 to retrieve information associated with the corresponding SDIA of an account. In some instances, the linking module can identify credentials stored in the life insurance account information 124 that can be used to access the direct investment platform 150 via the linking module 158 in the direct investment platform 150. Various types of authentication and/or handshaking can be used to ensure privacy and security, including public/private key encryption, secure channels, and other techniques and solutions.

The loan and deaccumulation module 120 can be used to determine plans and payments associated with the reduction of the cash value of a life insurance policy through periodic payments and reductions in cash value. For example, permanent life insurance can be used as a retirement or other savings vehicle, such that the cash value can be reduced to provide income and/or payments to the policy owner. Additionally, the loan and deaccumulation module 120 may also handle and support various policy loan requests, including determinations on amounts available to loan and repayment schedules. The module 120 can manage repayment schedules

The life insurance platform 102 further includes a presentation module 130. The presentation module 130 can be used to generate web interfaces related to the life insurance policy, including providing the functionality for submitting life insurance applications, reviewing policy documents and information, and for managing life insurance information. While the investment account is located at the separate and distinct direct investment platform 150, the presentation module 130 can access, via, e.g., the linking module 118, information about the investment account. The information can then be presented along with the life insurance information via the web-based interface to present a more complete illustration of the life insurance policy and associated SDIA.

The life insurance platform 102 further includes an insurance approval review system 134. The insurance approval review system 134 can assist in the initial determination of whether a life insurance application will be approved, approved with limitations, or rejected. The insurance approval review system 134 may include automated rules to determine whether the application is accepted, including rules to determine if additional medical and/or personal information may be necessary prior to a decision. The insurance approval review system 134 may be associated with one or more other systems, including by sending requests for an administrator or other insurer agent to perform a follow-up interview or analysis prior to issuing a policy.

The direct investment platform 150 represents a computer system, including one or more servers, computers, processors, and other components, that supports and maintains the SDIAs associated with one or more life insurance policies of the life insurance platform 102. In some instances, the direct investment platform 150 can also manage and maintain investment accounts unrelated to life insurance policies as well. The direct investment platform 150 can be maintained by a related company to the life insurer associated with the life insurance platform 102 or by an associated third-party administrator contracting with the life insurer to provide the associated SDIA. As illustrated, the direct investment platform 150 includes an interface 152, a processor 154, a direct investment online manager 156, a memory 164, and a presentation module 170. In general, the direct investment platform 150 is a simplified representation of one or more systems and/or servers that provide and maintain the self-directed insurance accounts, and is not meant to be limiting, but rather an example of the systems possible.

Interface 152 and processor 154 may be similar to interface 104 and processor 106, and memory 164 may be generally similar to memory 122. Memory 164, as illustrated, includes information on one or more self-directed investment accounts 166, as well as administrative and investment settings 168. The self-directed investment account information 166 can include information defining the particular investments bought for a specific account, the current values (realized and non-realized), the margin value of the account, and other information relevant to the SDIA. The settings 168 can include information on how such accounts are managed, rules for auto-rebalancing individual accounts, user preferences, investment timing information, and other setting and administrative information. The self-directed investment account information 166 can include unique identifiers identifying the account, which may match identifiers also associated with the life insurance account information. The correlations between the unique identifiers of the pair of accounts can allow quick commingling of information for web interfaces prepared and provided by presentation module 170 (or 130).

The direct investment online manager 156 performs the operations associated with managing and maintaining the SDIAs. As illustrated, the direct investment online manager 156 includes a linking module to the life insurance system 158 and a self-directed investment manager 160. The direct investment online manager 156 can electronically access data stored at the life insurance platform 102, store the data at the direct investment platform 150, and transform the data used to present account-related information. The linking module 158, similar to the linking module 118, allows the direct investment online manager 156 to access information related to the life insurance policy and use that information in managing the self-directed insurance account. For example, the direct investment online manager 156 may access information on the policy amount, current cash value, margin account value, and other information from the life insurance account information 124. The self-directed investment manager 160 performs the specific management of the investment account and can provide tools to policy owners for buying, selling, and otherwise managing their insurance accounts. The margin account manager 162 can interact with the margin account module 114 of the life insurance platform 102 to identify the current margin account value for a SDIA and allow the user to invest up to the maximum value in the margin account, if so desired. The self-directed investment manager 160 and the margin account manager 162 can use the linking module 158 to access relevant information from the life insurance policy for use in investment and account determinations. To that end, the direct investment platform 150 includes a presentation module 170. The presentation module 170 can prepare and present information associated with the SDIA to users, such as users using the client application 182 at client 180. The presentation module 170, using the linking module 158, can access the life insurance platform 102, identify relevant information to be presented from the life insurance account information 124, and can include that information in the presentation to the account owner along with information specific to the SDIA. This presentation can allow policy owners to manage their life insurance policy and the associated SDIA through one web interface, greatly simplifying the process previously used to manage their accounts while also providing significant flexibility in investing funds associated with the insurance accounts.

The system may also be able to identify any assets held under any of the user-directed investment accounts associated with the account holder for the purposes of allowing the account holder to collateralize option derivatives in the SDIA account that are written on assets held in other user-directed investment accounts. Still further, the system may be able to identify any assets held in any of the user-directed investment accounts to facilitate margin calculations for the purposes of trading within the SDIA. For example, the margin may be increased based on any assets held in any of the user-directed investment accounts, not only the SDIA.

While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

FIG. 2 is a swim-lane diagram 200 illustrating example operations at a direct investment platform 205 and a life insurance platform 210 for initiating and onboarding combined life insurance accounts with self-directed investment accounts. The direct investing platform 205 may be similar to or different from the direct investment platform 150, while the life insurance platform 210 may be similar to or different from the life insurance platform 102 of FIG. 1.

In many cases, customers of a direct investment platform 205, such as those who already have an account managed by the direct investment platform 205, may be excellent candidates for life insurance coverage. At 220, an existing investment client can receive a promotion related to a particular life insurance product as described in the present text. Using a link included in the promotion (e.g., via a marketing email or a pop-up box in a web-based interface), or by navigating to the life insurance platform, the investment client can request a quote via the life insurance platform, such as by completing a personal information and health questionnaire representing the insurance application, at 225. When at the site, the potential life insurance customer can calculate their needs for insurance while estimating the insurance premiums and contribution levels needed to meet those needs. Various account scenarios and projections may be calculated by the life insurance platform 210 to illustrate potential savings and cash values, as well as potential tax savings information.

Once the life insurance application is submitted, the life insurance platform 210 and the life insurer can assess, at 230,the risk and determine the appropriate rates to offer, if any, the applied-for life insurance policy. In some cases, the insurer may decide that additional medical testing or information may be needed to perform a full risk analysis. In some implementations, an automated decision tool may be used to determine whether to offer the life policy and at what rates based on the information received from the application.

At 235, a life insurance policy is issued at the determined rates and for an initial amount. When issuing the policy, the life insurance policy is assigned and/or associated with a unique customer identifier (ID). At 240, the life insurance platform 210 notifies the direct investment platform 205 of the new life insurance policy. At 245, the direct investment platform 205 can initiate and provide access to a self-directed insurance account. The self-directed insurance account can be assigned to or associated with the same unique customer ID as the life insurance policy at the life insurance platform 210. In some instances, the customer IDs may not be identical, but instead can be complementary or otherwise associated with one another to allow for correlation between the accounts. Once the SDIA is set up, the account tools provided by the direct investment platform 205 can be used to manage the SDIA similar to other investment accounts. As noted above, the amount available to invest in the SDIA may be directed related to the margin account approved for the policy owner based on a suitable rule set or determination. In one instance, the direct investment platform 205 can provide information related to the current contribution levels made to the life insurance policy at the life insurance account, and can provide feedback and projections related to alternative payments and additional premiums paid. By allowing the policy and account owner to actively review their deposits and manage investments, significant advantages can be realized, including a real-time adjustment of the insurance account, personalized projections, and manual management of the account and policy. As information related to the life insurance policy is presented at the direct investment platform 205, constant updates of the relevant information can be performed to ensure only up-to-date information is presented to the account owner. While the accounts are managed by two different systems, the operations of the system allow for seamless presentation of information from both accounts such that users may be unaware that the information is being managed by the different systems. In some instances, when the account owner requests a projection at the direct investment platform related to the life insurance account, the life insurance platform 210 may be performing the calculations and sharing the results to the direct investment platform 205.

As illustrated, at 250, an agent of the life insurer (or alternatively, of the direct investment platform 205) may initiate a phone call following up on the new life insurance policy (or the new SDIA). The follow-up call can allow the life insurance agent to provide further assistance in setting up the insurance account, as needed, and to instruct the policy owner on any matters of interest.

FIG. 3 is a flowchart of an example method 300 for presenting a unified set of account information from a life insurance account and a separate, but related, self-directed investment account. For clarity of presentation, the description that follows generally describes method 300 in the context of the system 100 illustrated in FIG. 1. However, it will be understood that method 300 may be performed, for example, by any other suitable system, environment, software, and hardware, or a combination of systems, environments, software, and hardware as appropriate.

At 305, login information is received from a user of a direct investment platform. The login information allows the direct investment platform to authorize the user and prepare a presentation of information related to the user's account. The login information may be associated with a unique customer ID. In some instances, the customer ID may be a part of the user's login information (e.g., a user name), while in other instances the unique customer ID may be linked to the user's login credentials.

At 310, one or more direct investment accounts associated with the customer ID are identified. These direct investment accounts can include traditional investment accounts, retirement accounts, and, for the purposes of this application, at least one self-directed insurance account.

At 315, life insurance account information associated with the customer ID is accessed from a life insurance platform. In some instances, the direct investment platform can query the life insurance platform to retrieve the information, while in others, the direct investment platform can directly access the life insurance platform, such as via predefined APIs providing access, with authorization, to the life insurance platform and information associated with particular accounts. Further, the insurance account information may be provided to the direct investment platform from the life insurance platform using data extracts on a periodic basic, such as monthly.

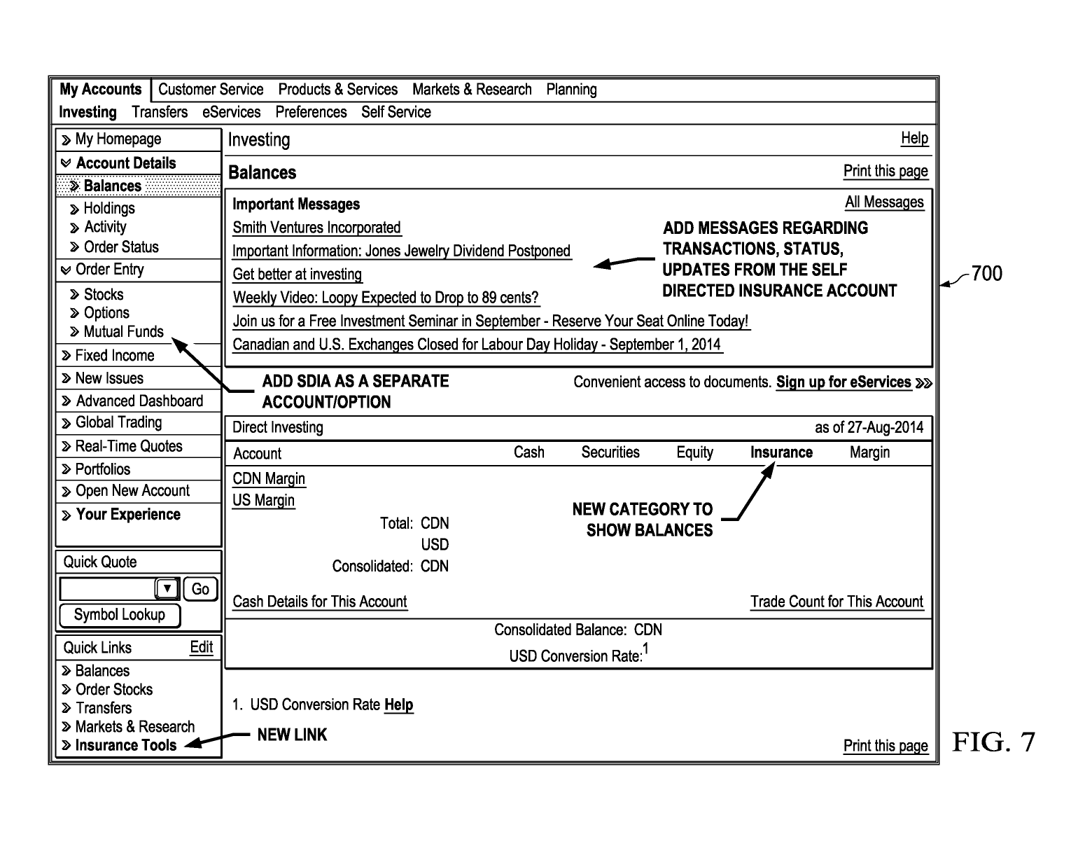

At 320, the identified direct investment accounts and the life insurance account information associated with the customer ID obtained from the life insurance platform are integrated into a combined record set for presentation. The information from the life insurance platform can be seamlessly integrated into the information associated with the direct investment accounts associated with the login information. FIGS. 7-10 provide examples of the integration of information from different systems.

At 325, the combined information is presented via a web interface for viewing and interaction within the direct investment platform. In many instances, the information is interactive and can be modified by the user. For interactions with the life insurance account information, requests can be received via the web interface, transmitted to the life insurance account, and updated information returned to the direct investment platform for viewing.

While method 300 assumes that login information is received at a direct investment platform, alternative implementations may allow the information to be presented via a web interface associated with the life insurance platform, with information related to the investment accounts being obtained from the direct investment platform and presented via the life insurance platform's web interface.

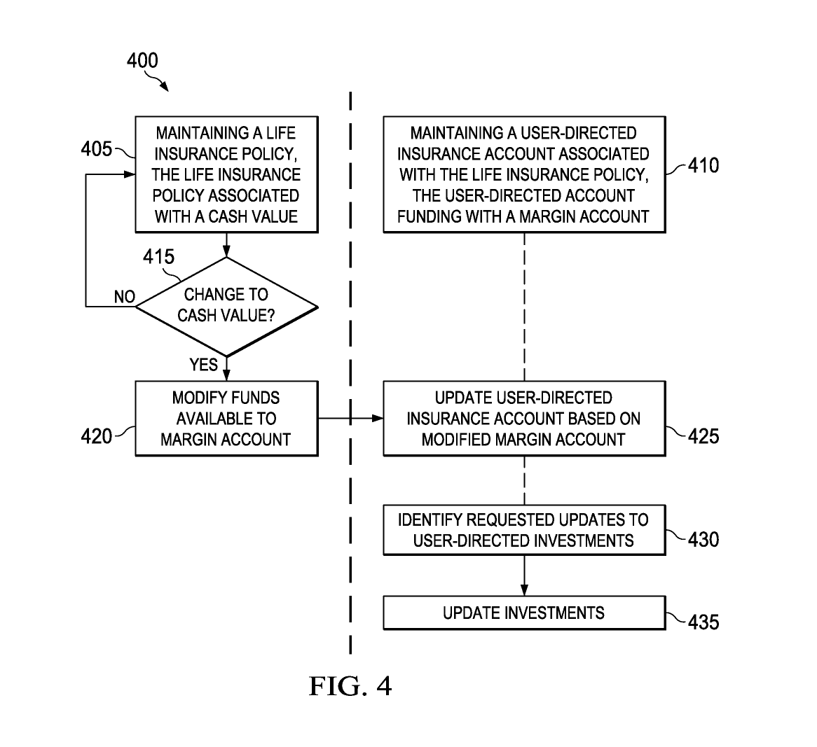

FIG. 4 is a flowchart of an example operations (400) for maintaining a life insurance account and a separate, but related, self-directed investment account. Operations 405 and 410 can occur concurrently after initiating and onboarding the life insurance policy and associated self-directed (or user-directed) investment account.

At 405, a life insurance policy and account are maintained at a life insurance platform, where the life insurance policy is associated with a cash value. Concurrently, at 410, a user-directed insurance account associated with the life insurance policy is maintained at a direct investment platform, where the user-directed account is funded with a margin account directly associated with the cash value of the life insurance policy. The margin account represents a pre-determined percentage of the cash value of the life insurance policy and can be used to fund the user-directed insurance account.

At 415, a determination is made as to whether a change to the cash value of the life insurance policy has occurred. If not, the operations return to 405. If a change has occurred, such as additional premiums combining the cost of insurance and an additional amount for savings, the cash value of the life insurance policy will increase. As a result of the change, the life insurance platform can automatically modify the funds available to a margin account associated with the cash value of the life insurance policy at 420. The life insurance platform can then notify the direct investment platform of the change in the margin account. Alternatively, the direct investment platform may watch or identify the change itself, such that no notification is required.

At 425, the user-directed insurance account is updated based on the modified margin account. In some instances, the update may result in an automatic investment by the direct investment platform as defined by the account owner. Alternatively, the account owner may be notified or become otherwise aware of the additional available funds and can direct the investment of those funds at a later time. At 430, updates to the user-directed investments are identified, and at 435, the identified investments are made and the user-directed insurance account is updated accordingly.

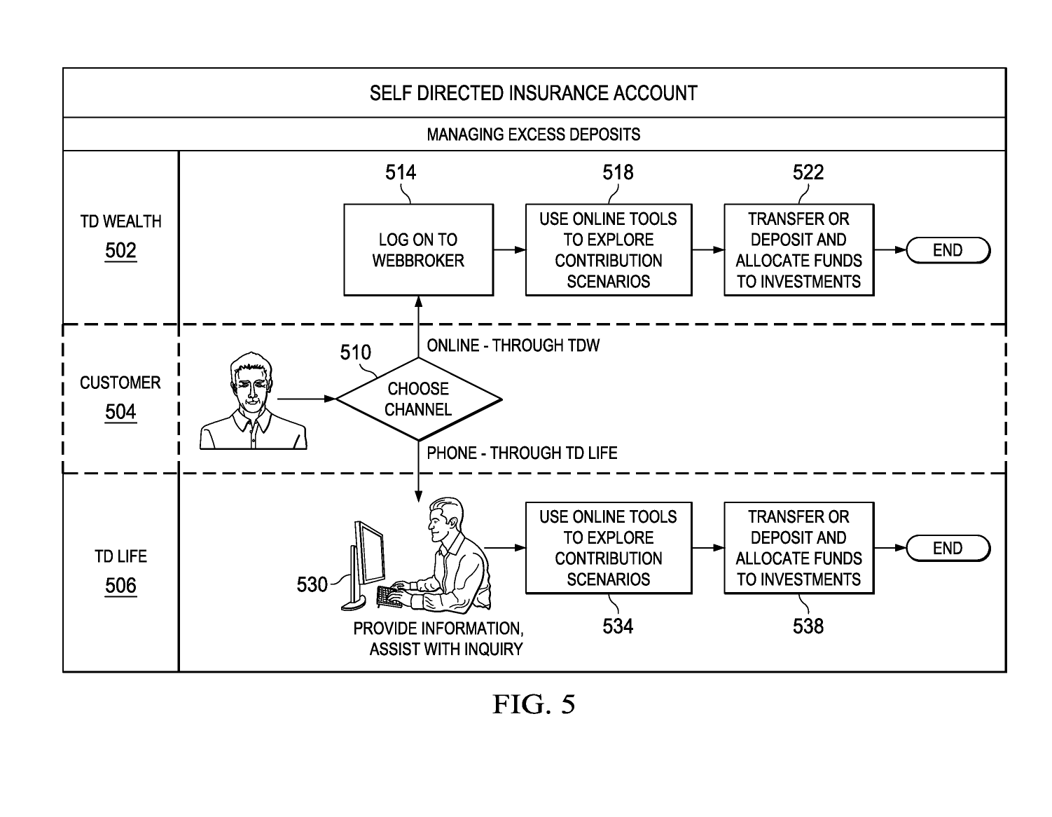

FIG. 5 is a swim-lane diagram illustrating example operations for managing excess deposits into a life insurance policy described in the present application. Specifically, the new insurance investment accounts described herein allow customers 504 (or policy owners) to choose how to apply excess deposits above the insurance minimum. The customer 504 can elect (at 510) to apply the excess deposits via either the life insurance platform 506 (via phone call to the life insurer's live support) or through the web interface provided by the direct investment platform 502.

Should the user elect to perform the application through the live support of the life insurance platform 506, the user can phone a live agent (530). The live agent can provide information and assist with the additional investment. At 534, the live agent can use online tools to explore contribution scenarios for the policy owner and can manage the transfer or deposit and allocation of funds to particular investments selected by the policy owner at 538.

If the user elects to perform the investments himself, he can log into the web interface at 514. At 518, the user can use the online tools to explore contribution scenarios and/or investment options. Based on this research, the customer 504 can then transfer or deposit the allocated funds into the investments via the self-directed insurance account (522).

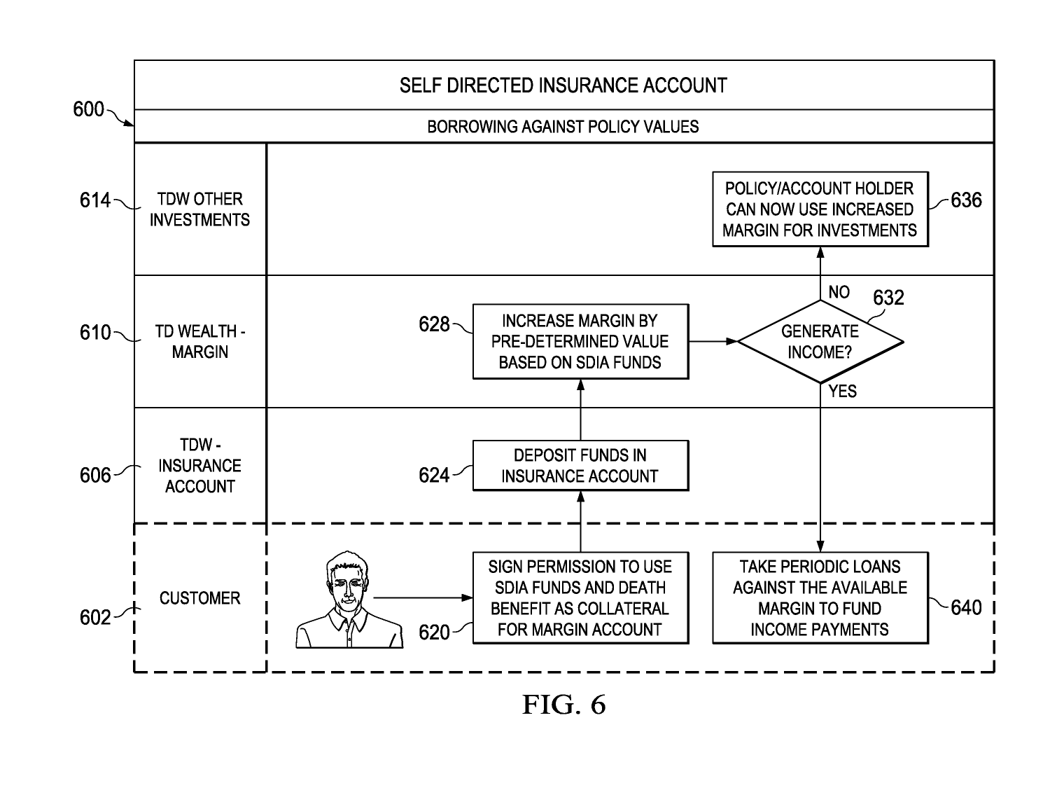

FIG. 6 is a swim-lane diagram illustrating example operations (600) for usage of a margin account associated with and backed by the life insurance policy, where the account owner can invest or deaccumulate the margin account.

Prior to using a margin account, customers 602 (policy owners) must apply for and be authorized for using self-directed insurance accounts as collateral for a margin account (620). Upon doing so, and upon approval, the direct investment platform 606 managing the insurance account can receive a deposit (624). The deposit, as described previously, can be based on a margin value associated with the cash value of the insurance policy.

At 628, the direct investment platform 610 managing a larger margin account (i.e., based on, for example, funds outside of the self-directed insurance account) can increase the existing margin by a predetermined value (e.g., a set percentage or calculation) of the cash value of the insurance policy. In fact, different investments or values may be margined at different rates. For example, cash may be margined 100%, while securities may be margined at a different rate related to the particular security. In some instances, the margin account may be first created in response to opening the life insurance policy, in which there will be a new margin account generated and new funds deposited into the account. The amount of the increased margin available based on the cash value of the insurance policy can, as described above, be customized by the direct investment platform and/or the life insurance platform to represent an acceptable level of risk associated with the individual and the loan as compared to the cash value of the insurance policy.

At 632, the direct investment platform 610 determines whether the current margin account is to be used to generate income. The determination may be based on the policy and account holder's preferences and/or instructions. If no income is to be generated, then at 636, the policy and account holder can use the increased margin for additional investments using the direct investment platform. If income is requested, then at 640, the policy and account holder can receive periodic loans against the available margin to fund income payments. This can be considered a deaccumulation of the margin account and allows policy owners to create cash without liquidating the investment. In some instances, receiving loans via the margin account may create fewer taxable transactions than a liquidation of other investments, thereby providing a savings to the policy holder.

In some implementations, the direct investment platform may perform additional checks to reduce the taxable impact of the SDIA. For example, the direct investment platform may monitor investments to ensure that such investments do not exceed tax sheltered maximum amounts permitted by law (i.e., without incurring taxable obligations). In those instances, investments over the maximum non-taxable amount may be transferred automatically to another, separate account. The direct investment platform can provide a notification mechanism such that the account holder makes the final decision over which assets are to be transferred. If the notification is not answered, the direct investment platform may move the funds based on pre-defined rules and/or instructions.

Additionally, the direct investment platform and associated advisors may provide account holders with monthly or periodic information related to the investments, including the maximum contribution levels available (e.g., without a taxable obligation) based on past investment results and the level of insurance coverage. The direct investment platform may also automate tax advice related to which assets should or could be transferred to the SDIA.

FIGS. 7-10 are example screenshots providing illustrations of various web interfaces incorporating information from both an investment platform and a life insurance platform in seamless combination.

FIG. 7 represents a welcome page 700 associated with a web interface for the direct investment platform. The welcome page 700 provides simple user access to the self-directed accounts and the insurance information directly from the welcome screen to the investment platform.

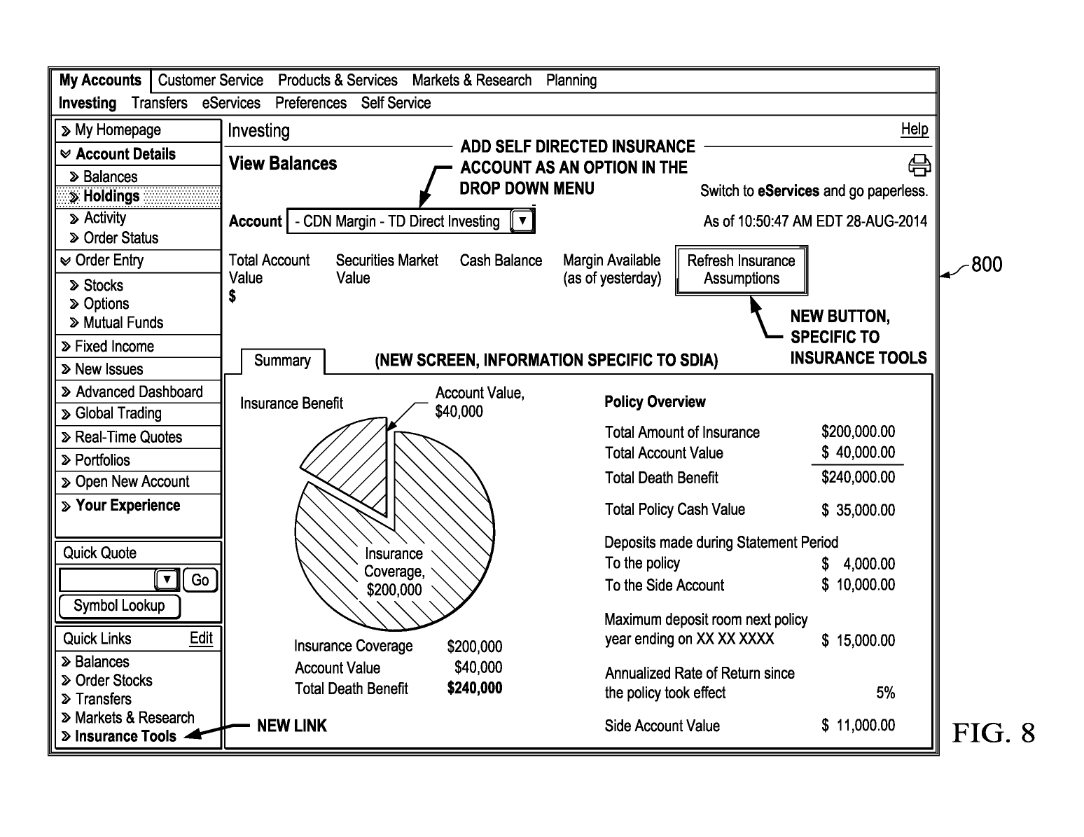

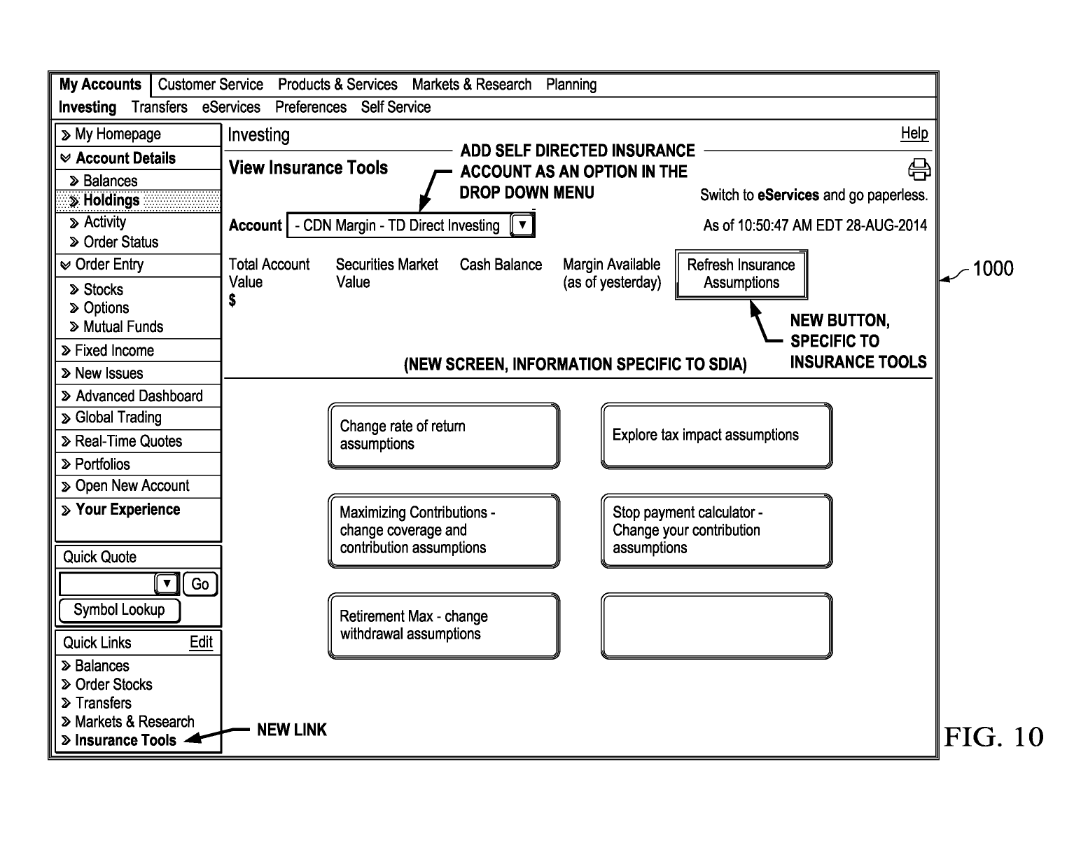

FIG. 8 represents an example of a “View Balances” page 800 presented via the web interface. As shown, information about the life insurance account is seamlessly included in the listing of other investments maintained at the direct investment platform, even in light of the life insurance policy being managed and maintained at a separate and distinct life insurance platform. Information related to the life insurance account and SDIA, in part from the SDIA maintained at the direct investment platform and in part from the life insurance policy at the life insurance platform, is presented in a single page. Interactions, such as “Refresh Insurance Assumptions”, may be available that can trigger actions at the life insurance platform via the web interface for the direct investment platform. As illustrated here, the button may be associated with a SDIA tools page, such as shown in FIG. 10.

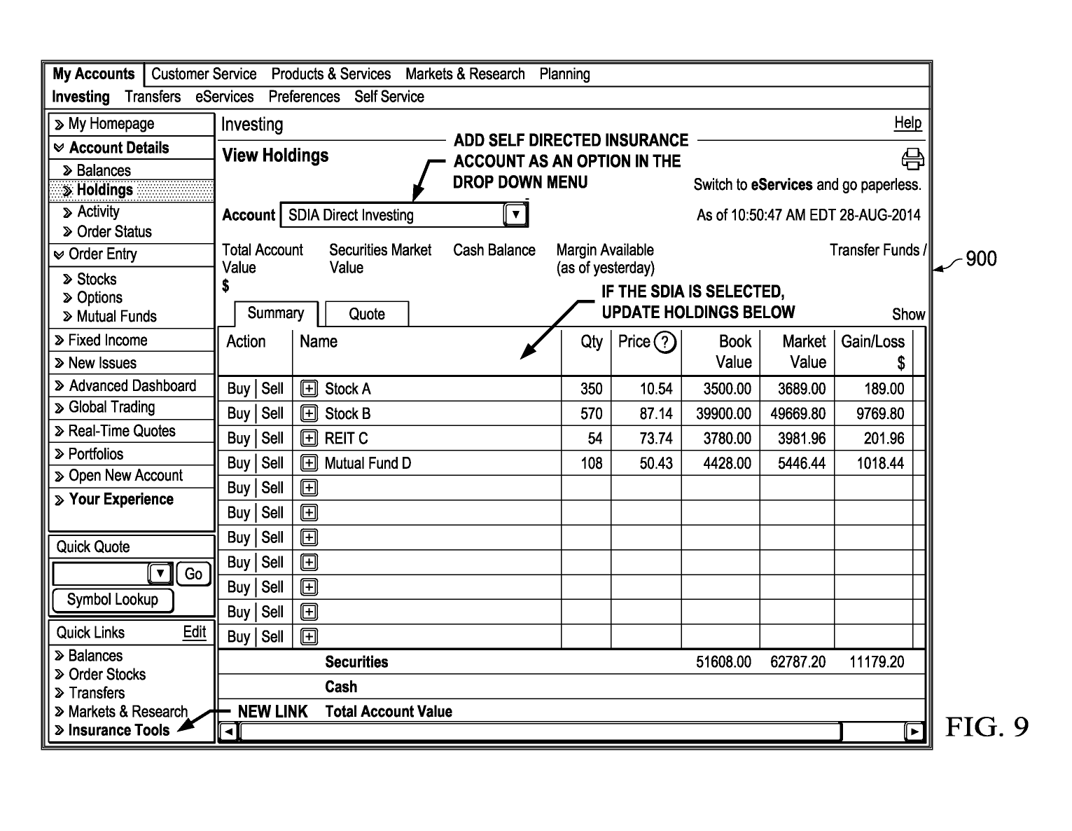

FIG. 9 represents a screen 900 wherein the account holder can identify, buy, and sell various investments for the SDIA through the web interface of the direct investment platform. Such a page may be similar to those previously available at the direct investment platform, but which instead are associated with the SDIA.

FIG. 10 represents a new screen 1000 available at the web interface of the direct investment platform wherein the policy owner can access tools to manage the SDIA. As illustrated, tools may be available to modify and view various calculations associated with the SDIA, including the rate of return assumptions and tax impact assumptions. Additionally, tools may be available to assist the policy and account holder in maximizing contributions within a non-taxable range, as well as how to modify insurance coverage to allow tax-minimized increases to contributions. Further, retirement deaccumulation may be managed through the screen 1000, as well as projections related to contribution assumptions. Various additional and alternative tools and functionality may be available in other implementations.

The preceding figures and accompanying description illustrate example systems, processes, and computer-implementable techniques. While the illustrated systems and processes contemplate using, implementing, or executing any suitable technique for performing these and other tasks, it will be understood that these systems and processes are for illustration purposes only and that the described or similar techniques may be performed at any appropriate time, including concurrently, individually, or in combination, or performed by alternative components or systems. In addition, many of the operations in these processes may take place simultaneously, concurrently, and/or in different orders than as shown. Moreover, the illustrated systems may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A system comprising:
a life insurance platform including at least one processor that executes operations to maintain a life insurance policy for a user, the life insurance policy associated with a cash value that is backed by investment assets;
a user-directed investment account platform including at least one processor that executes operations to maintain a user-directed investment account associated with the life insurance policy, wherein the user-directed investment account is initially funded with a cash account and/or a margin account, wherein the margin account is based at least in part on a cash value of the life insurance policy;
wherein at least one of the life insurance platform and the user-directed investment account platform further includes at least one processor that executes operations to:
determine a delta of the value of the investment assets backing the cash value of the life insurance policy; and
modify the value of the margin account based on the determined delta;
wherein the user-directed investment account platform further includes at least one processor that executes operations to:
identify the modified value of the margin account;
store the modified value of the margin account; and
update the user-directed investment account based on the modified value of the margin account; and
wherein the user-directed investment account platform further includes at least one processor that executes operations operable to:
provide a web-based interface for providing information related to the user-directed investment account, wherein the web-based interface presents account details of the user-directed investment account;
access the life insurance platform to identify information related to the life insurance policy; and
present, via the web-based interface, at least a portion of the identified information related to the life insurance policy with the account details of the user-directed investment account.

2. The system of claim 1, the user-directed investment account platform further operable to allocate investment assets associated with the life insurance policy based on direct instructions from the user.

3. The system of claim 2, wherein the value of invested assets can be used against the value of the margin account to fund periodic income payments to the user.

4. The system of claim 2, wherein the life insurance platform is maintained by a first entity providing life insurance policies, and wherein the direct investing platform is maintained by an investment firm.

5. The system of claim 4, wherein the direct investing platform is managed by a third-party administrator distinct from the first entity managing the life insurance platform.

6. The system of claim 1, wherein the identified information related to the life insurance policy is presented seamlessly in-line with the account details of the user-directed investment account.

7. The system of claim 1, wherein at least a portion of the funds in the user-directed investment account are used to pay at least a portion of premiums for the life insurance policy.

8. The system of claim 1, wherein the user-directed investment account platform is operable to electronically invest funds in the user-directed investment account in one or more of the following: individual equities, options, bonds, money market offerings, mortgage-backed securities, real estate-backed securities, real estate investment trusts (REITs), exchange-traded funds (ETFs), mutual funds, index funds, and precious metal certificates.

9. The system of claim 1, wherein the life insurance policy is a universal life insurance policy.

10. The system of claim 1, wherein the value of the margin account is a pre-determined percentage of the cash value of the life insurance policy.

11. The system of claim 1, wherein the margin account includes at least one asset other than the value of the life insurance policy.

12. The system of claim 1, wherein the margin account is calculated, at least in part, on at least one asset held in a different user-directed investment account.
